(19) United States
(12) Patent Application Publication
(10) Pub. No.: US 2024/0335254 A1
(43) Pub. Date: Oct. 10, 2024

(54) Palatal Splint

(71) Applicant: KLS Martin, L.P., Jacksonville, FL (US)

(72) Inventors: Travis Simpson, Jacksonville, FL (US); Elliott Pearson, Jacksonville, FL (US)

(73) Assignee: KLS Martin, L.P., Jacksonville, FL (US)

(21) Appl. No.: 18/630,982

(22) Filed: Apr. 9, 2024

Related U.S. Application Data
(60) Provisional application No. 63/458,378, filed on Apr. 10, 2023.

(51) Int. Cl. A61C 5/00

(52) U.S. Cl. CPC A61C 5/007

(57) ABSTRACT

A palatal splint composed of titanium or other metal of similar characteristics, the splint configured in a horseshoe or strut configuration and designed to minimize coverage and contact with the teeth. The splint has alternating tooth recesses and interdental extensions.

### BACKGROUND OF THE INVENTION

This application relates to implants utilized in oral or maxillofacial facial surgery or other treatment methodologies, and more particularly relates to palatal splints which when implanted do not cover the teeth.

Splints are valuable tools used to distribute forces, decrease occlusal trauma and protect against excess tooth mobility due to primary or secondary occlusal trauma. Surgical stabilizing splints are indicated to provide (1) stability in multiple segmental surgery of the maxilla or mandible, (2) transverse stability when the maxilla and/or mandible have been expanded or narrowed, (3) occlusal support when key teeth are missing (e.g., when first, second, and third molars are missing in a quadrant), and (4) a means to interdigitate the occlusion if teeth are severely worn or missing. One basic type of maxillary splint used in orthognathic surgery is the palatal splint. The splint may be provided as a domed palatal splint, a horseshoe-shaped palatal splint or a palatal strut splint. The splints are constructed to help stabilize the maxillary bone segments to enhance healing.

In many circumstances the preferred shape is a horseshoe-shaped splint because it provides excellent stability, the occlusal interrelations can be maximized and observed as the teeth and occlusal relations are not covered and hidden by the splint, cleaning of the exposed teeth is easier, orthodontic treatment can be performed with the splint in place, and it can be left in place for extended periods of time.

The major challenges encountered in the design and production of a palatal splint are designing a splint that accurately captures the occlusal scheme, is not too bulky, protects the opposing dentition, and enables patients to adapt to and wear the splint long term. A representative horseshoe-shaped palatal splint known in the art is illustrated in prior art FIGS. 1 and 2. The splint is formed of a polymer material, which is a problem in that an undesirable bulkiness and thickness of material is required to provide the required strength and rigidity.

It is an object of this invention to provide an improved palatal splint, the improvement resulting from the choice of a stronger material of composition (e.g., titanium), which allows for a more streamlined profile, a reduction of contact with the teeth and a better patient experience.

### BRIEF SUMMARY OF THE INVENTION

The invention comprises in various embodiments as discussed and illustrated, the drawings as presented intended to be illustrative and not restrictive, a palatal splint composed of titanium or a metal having similar properties suitable for use in the human body and which provides similar properties for manufacture and design of the splint to achieve desired strength and rigidity. By virtue of the material of composition, the splint may be constructed with a reduced thickness and a reduced dimensional extent in comparison to splints manufactured of polymer materials.

In one embodiment, the palatal splint comprises a generally U- or horseshoe-shaped main body having an abutting edge comprising tooth recesses and interdental extensions or prongs whereby the tooth recesses are adapted to abut the base of a tooth and the interdental extensions area adapted to be positioned in the interdental spaces between adjacent teeth. Wire apertures are provided near the abutting edge and are adapted to receive wires wrapped around the teeth to secure the device on the palate. Fixation apertures adapted to receive bone screws may be disposed in the main body if it is necessary to provide additional securement by driving the screws into bone material. In a preferred embodiment, the abutting edge is thicker than the main body to provide greater rigidity and strength for the wire securement.

In alternate embodiments, the main body may be designed and structured as a transverse strip or bar extending laterally across the dental arch, or the main body may be designed as three-armed body extending transversely and anteriorly across the dental arch.

The palatal splint is a customized, patient-specific splint created using known methods of computer aided design wherein CT scanners or like imaging means are used to create virtual 3-D models of a given patient such that the splint can be designed to match the exact dimensions, shapes and configurations of the patient's dental arch, teeth, lingual gum and palate using software, Al and/or human input from technicians or surgeons.

In alternative language, the invention in various embodiments is a palatal splint adapted to be affixed to an upper dental arch and palate, the upper dental arch having teeth with lingual bases defining interdental spaces, and the palate having gingival tissue; the palatal splint composed of titanium or a metal having similar properties, the palatal splint comprising a main body having an abutting edge, tooth recesses, interdental recesses and wire apertures, wherein the abutting edge is thicker than the main body; wherein the palatal splint is manufactured using computer aided design based on a virtual model of the upper dental arch and palate of a patient such that with the palatal splint affixed to the upper dental arch and palate, the abutting edge, the tooth recesses and the interdental recesses rest on the gingival tissue of the palate and do not contact the lingual bases of the teeth. Furthermore, the invention as described above wherein said main body is horseshoe-shaped; is further comprising another main body, wherein the main bodies are connected by a transverse strut; is further comprising two other main bodies, wherein the main bodies are connected by a T-shaped strut; and/or is further comprising fixation apertures disposed in the main body.

### DESCRIPTION OF THE DRAWINGS

FIG. 1 illustrates a prior art horseshoe-shaped palatal splint composed of a polymer material.

FIG. 2 illustrates the prior art horseshoe-shaped palatal splint disposed on a computer model of the upper dental arch and palate of a typical patient.

FIG. 3 illustrates a horseshoe-shaped embodiment of the palatal splint of the invention.

FIG. 4 illustrates the horseshoe-shaped palatal splint of FIG. 3 disposed on a computer model of upper dental arch and the palate of a patient.

FIG. 5 illustrates an alternative embodiment of the palatal splint disposed on a computer model of upper dental arch and the palate of a patient, in this case a palatal strut splint extending laterally across the palate.

FIG. 6 illustrates another embodiment of the horseshoe-shaped palatal splint.

FIG. 7 illustrates another embodiment of the horseshoe-shaped palatal splint.

FIG. 8 illustrates another embodiment of a palatal strut splint, in this case a tri-armed palatal splint.

FIGS. 9 through 11 illustrate the horseshoe-shaped palatal splint of FIG. 7 disposed on a computer model of the dental arch and palate of a typical patient, as seen from various angles.

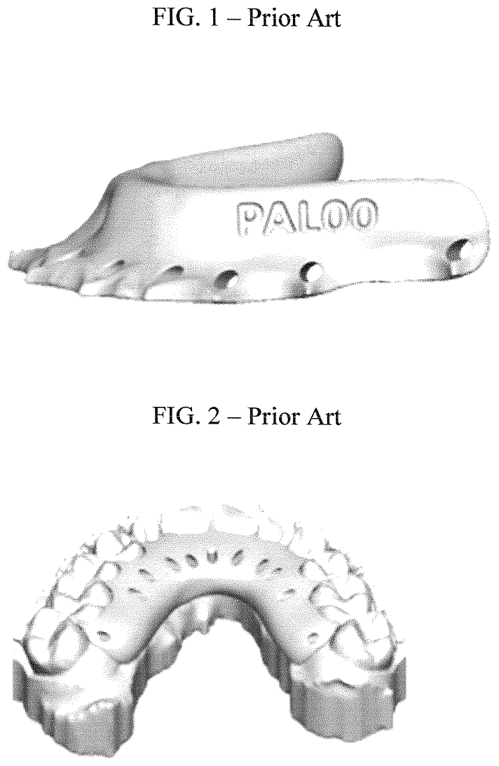

### DETAILED DESCRIPTION OF THE INVENTION

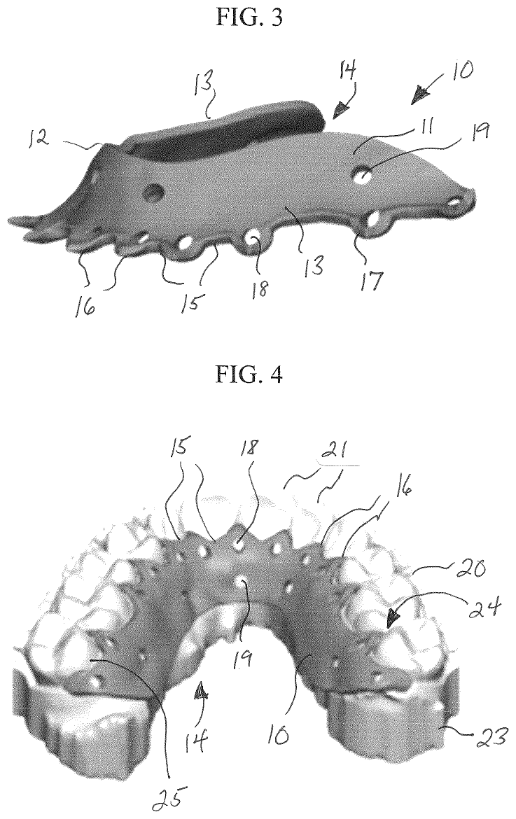

A basic embodiment of the palatal splint is shown in FIGS. 3 and 4. The palatal splint 10 comprises a main body 11 configured generally in a horseshoe or U-shape, the main body having an anterior or frontal portion 12 and two lateral or side portions 13. The main body 11 is configured in known manner thorough computer-aided design to match the configuration of the palatal and lingual gum surfaces of the patient, such that the main body 11 slopes upwardly and inwardly. The horseshoe-shaped main body 11 corresponds to the dental arch and the lingual surfaces of the gum and palate of the patient. The shape of the main body 11 also provides a large open area 14 corresponding to the central portion of the palate.

The outer or lower perimeter of the main body 11 defines an abutting edge 13 which comprises alternating tooth recesses 15 and interdental extensions 16. The tooth recesses 15 are generally concave and are configured to rest adjacent and partially encircling the base of a tooth 21 in the upper dental arch 20 on the tooth's lingual side. The tooth recesses 15 are configured to expose as much of the lingual base surface 25 of the tooth 21 as possible while resting on the gingival/mucosal tissue 22 of the maxilla 23.

The interdental extensions 16 are disposed adjacent and between each tooth recess 15 and are projections configured to rest on the gingival/mucosal tissue of the maxilla 23. The interdental extensions 16 are generally tapered to provide each with a triangular or pointed shape that serves to properly position, stabilize and secure the palatal splint 10. As with the tooth recesses 15, the interdental extensions 16 are designed to expose as much of the lingual base surface 25 of the tooth 21 as possible.

The abutting edge 17 of the palatal splint 10, are at least the tooth recesses 15 and the interdental extensions 16, is preferably raised or thickened so as to be dimensioned larger than the main body 11. With the abutting edge 17 being thicker than the main body 11, the thickness of the main body 11 may be minimized without sacrificing the required rigidity and strength of the palatal splint 10, thereby reducing patient discomfort and requiring less material to form the splint 10.

Wire apertures 19 are provided in or adjacent some or all of the interdental extensions 16 to allow the palatal splint 10 to be secured in place by wrapping wires around some of the teeth 21.

Fixation apertures 19 may be provided in the main body 11 of the palatal splint 10 for affixation of the palatal splint 10 to the maxilla 23 with bone screws.

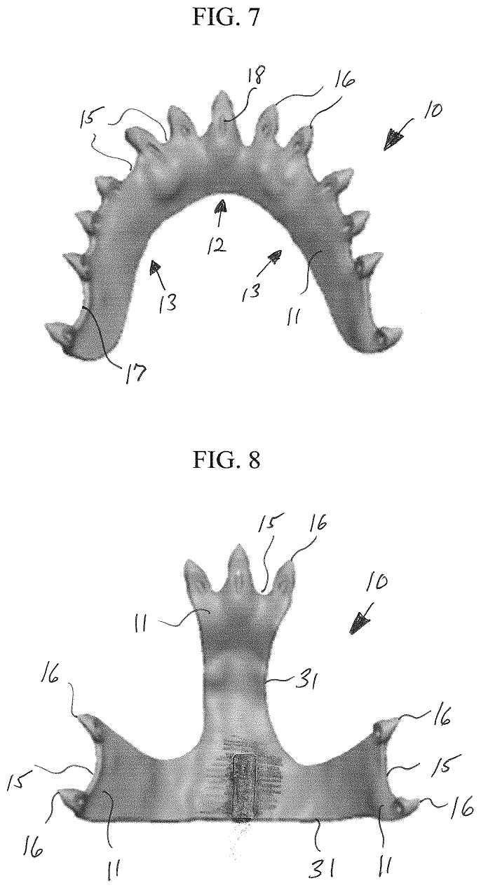

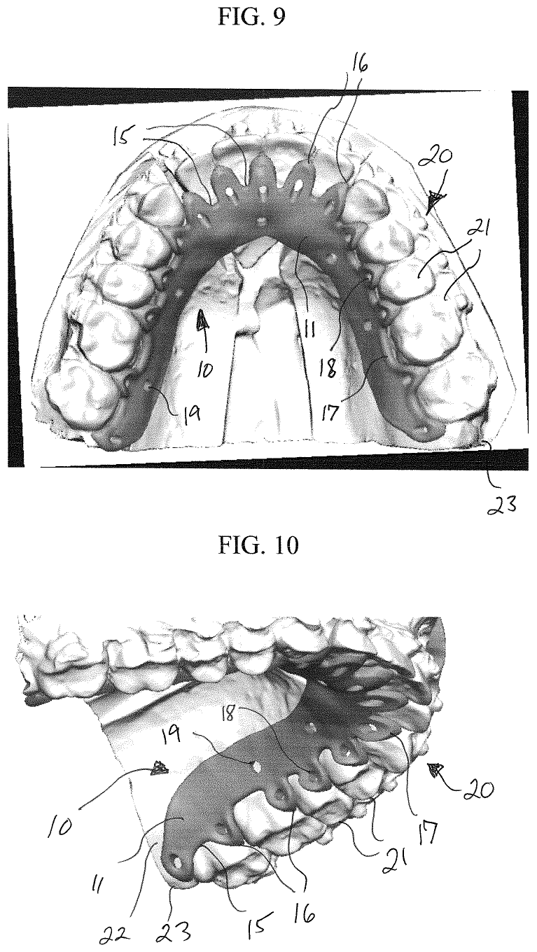

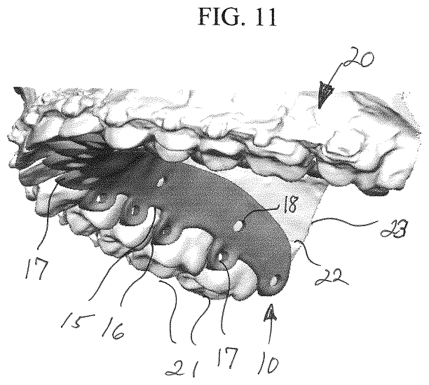

Alternative embodiments of the horseshoe shaped palatal splint 10 are shown in FIGS. 6 and 7 to illustrate that the splints 10 are customized to each patient.

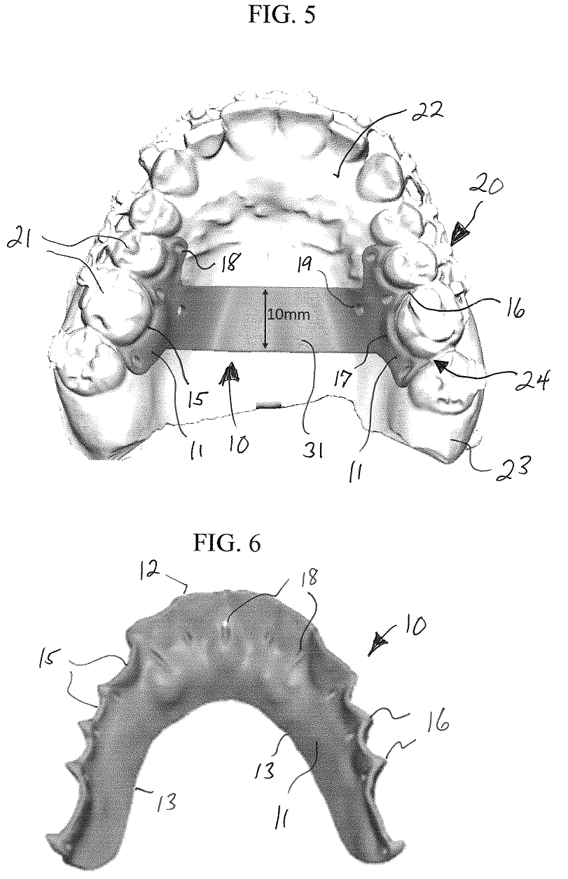

FIGS. 5 and 8 illustrates embodiments of the palatal splint 10 that are not configured in a horseshoe shape but instead comprise multiple main bodies 11 which are connected by a transverse strut 31. The embodiment of FIG. 5 shows a pair of main bodies 11 connected by a single strut or arm 31, while the embodiment of FIG. 8 shows three main bodies 11 connected by a T-shaped or tri-armed strut 31.

The palatal splint 10 is composed of a biocompatible, strong metal, such as titanium. This allows the splint 10 to be thinner, smaller and with less surface area than known prior art splints composed of a polymer. In particular, utilizing titanium of a similar metal allows the palatal splint to be designed such that contact with the tooth surfaces are minimized or non-existent. Such a construction reduces patient palpability and discomfort, provides for easier wiring or wire removal to the teeth due to the wire having to pass through less material, and is more conducive for screw fixation of the splint to the maxilla and palate.

It is to be understood that equivalents or substitutions to certain elements or structures set forth above may be obvious to those skilled in the art, and therefore the full scope and definition of the invention is to be as set forth in the following claims.

We claim:

1. A palatal splint composed of titanium or a metal having similar properties, the palatal splint comprising a main body having an abutting edge, tooth recesses, interdental recesses and wire apertures, wherein the abutting edge is thicker than the main body.

2. The palatal splint of claim 1, wherein said main body is horseshoe-shaped.

3. The palatal splint of claim 1, further comprising another main body, wherein the main bodies are connected by a transverse strut.

4. The palatal splint of claim 1, further comprising two other main bodies, wherein the main bodies are connected by a T-shaped strut.

5. The palatal splint of claim 1, further comprising fixation apertures disposed in the main body.

6. A palatal splint adapted to be affixed to an upper dental arch and palate, the upper dental arch having teeth with lingual bases defining interdental spaces, and the palate having gingival tissue;
the palatal splint composed of titanium or a metal having similar properties, the palatal splint comprising a main body having an abutting edge, tooth recesses, interdental recesses and wire apertures, wherein the abutting edge is thicker than the main body; and
wherein with the palatal splint affixed to the upper dental arch and palate, the abutting edge, the tooth recesses and the interdental recesses rest on the gingival tissue of the palate and do not contact the lingual bases of the teeth.

7. The palatal splint of claim 6, wherein said main body is horseshoe-shaped.

8. The palatal splint of claim 6, further comprising another main body, wherein the main bodies are connected by a transverse strut.

9. The palatal splint of claim 6, further comprising two other main bodies, wherein the main bodies are connected by a T-shaped strut.

10. The palatal splint of claim 6, further comprising fixation apertures disposed in the main body.

11. A palatal splint adapted to be affixed to an upper dental arch and palate, the upper dental arch having teeth with lingual bases defining interdental spaces, and the palate having gingival tissue;
the palatal splint composed of titanium or a metal having similar properties, the palatal splint comprising a main body having an abutting edge, tooth recesses, interdental recesses and wire apertures, wherein the abutting edge is thicker than the main body;
wherein the palatal splint is manufactured using computer aided design based on a virtual model of the upper dental arch and palate of a patient such that with the palatal splint affixed to the upper dental arch and palate, the abutting edge, the tooth recesses and the interdental recesses rest on the gingival tissue of the palate and do not contact the lingual bases of the teeth.

12. The palatal splint of claim 11, wherein said main body is horseshoe-shaped.

13. The palatal splint of claim 11, further comprising another main body, wherein the main bodies are connected by a transverse strut.

14. The palatal splint of claim 11, further comprising two other main bodies, wherein the main bodies are connected by a T-shaped strut.

15. The palatal splint of claim 11, further comprising fixation apertures disposed in the main body.
